(19) United States
(12) Patent Application Publication
(10) Pub. No.: US 2025/0097841 A1
(43) Pub. Date: Mar. 20, 2025

(54) UE-INITIATED CELL OPERATION ADAPTATION

(71) Applicant: Samsung Electronics Co., Ltd., Suwon-si (KR)

(72) Inventor: Jeongho Jeon, San Jose, CA (US)

(21) Appl. No.: 18/827,452

(22) Filed: Sep. 6, 2024

Related U.S. Application Data
(60) Provisional application No. 63/539,514, filed on Sep. 20, 2023.
(60) Provisional application No. 63/542,665, filed on Oct. 5, 2023.

(51) Int. Cl. H04W 52/02

(52) U.S. Cl. CPC H04W 52/0229

(57) ABSTRACT

Methods and apparatuses for a user equipment (UE)-initiated cell operation adaptation in wireless communication systems. A method for a user equipment (UE) includes receiving information related to transmission of a wake-up signal (WUS). The information includes at least a resource configuration and a triggering condition. The method further includes transmitting, based on (i) the resource configuration and (ii) whether the triggering condition is met, the WUS; receiving an on-demand synchronization signal block (SSB) or an on-demand system information block (SIB) on a cell; and determining synchronization or system information on the cell.

### CROSS-REFERENCE TO RELATED APPLICATIONS AND CLAIM OF PRIORITY

The present application claims priority to U.S. Provisional Patent Application No. 63/539,514, filed on Sep. 20, 2023, and U.S. Provisional Patent Application No. 63/542,665, filed on Oct. 5, 2023. The contents of the above-identified patent documents are incorporated herein by reference.

### TECHNICAL FIELD

The present disclosure relates generally to wireless communication systems and, more specifically, the present disclosure relates to a user equipment (UE)-initiated cell operation adaptation in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a UE-initiated cell operation adaptation in wireless communication systems.

In one embodiment, a method for a UE is provided. The method includes receiving information related to transmission of a wake-up signal (WUS). The information includes at least a resource configuration and a triggering condition. The method further includes transmitting, based on (i) the resource configuration and (ii) whether the triggering condition is met, the WUS; receiving an on-demand synchronization signal block (SSB) or an on-demand system information block (SIB) on a cell; and determining synchronization or system information on the cell.

In another embodiment, a UE is provided. The UE includes a transceiver configured to receive information related to transmission of a WUS. The information includes at least a resource configuration and a triggering condition. The transceiver is further configured to transmit, based on (i) the resource configuration and (ii) whether the triggering condition is met, the WUS; and receive an on-demand SSB or an on-demand SIB on a cell. The UE further includes a processor operably coupled to the transceiver, the processor configured to determine synchronization or system information on the cell.

In yet another embodiment, a base station (BS) is provided. The BS includes a processor and a transceiver operably coupled to the processor. The transceiver is configured to transmit information related to reception of a WUS. The information includes at least a resource configuration and a triggering condition; The transceiver is further configured to receive, based on (i) the resource configuration and (ii) whether the triggering condition is met, the WUS and transmit an on-demand SSB or an on-demand SIB on a cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates an example of a cell DTX/DRX according to various embodiments of the present disclosure;

FIG. 8 illustrates an example of a cell DTX/DRX activation/deactivation on a cell according to various embodiments of the present disclosure;

FIG. 9 illustrates a flowchart of UE method for transmitting WUS according to various embodiments of the present disclosure;

FIG. 10 illustrates an example of UE and gNB for transmission and response according to various embodiments of the present disclosure;

FIG. 11 illustrates a flowchart of UE method for transmitting WUS based on WUS transmission parameters according to various embodiments of the present disclosure;

FIG. 12 illustrates an example of UE for transmitting WUS based on WUS transmission parameters according to various embodiments of the present disclosure;

FIG. 13 illustrates a flowchart of UE method for switching between a first UL WUS and a second UL WUS according to various embodiments of the present disclosure;

FIG. 14 illustrates an example of UE for transmitting a first WUS and a second WUS according to various embodiments of the present disclosure; and

FIG. 15 illustrates a signaling flow of method for transmitting a first UL WUS and a second UL WUS between a UE and a gNB according to various embodiments of the present disclosure.

### DETAILED DESCRIPTION

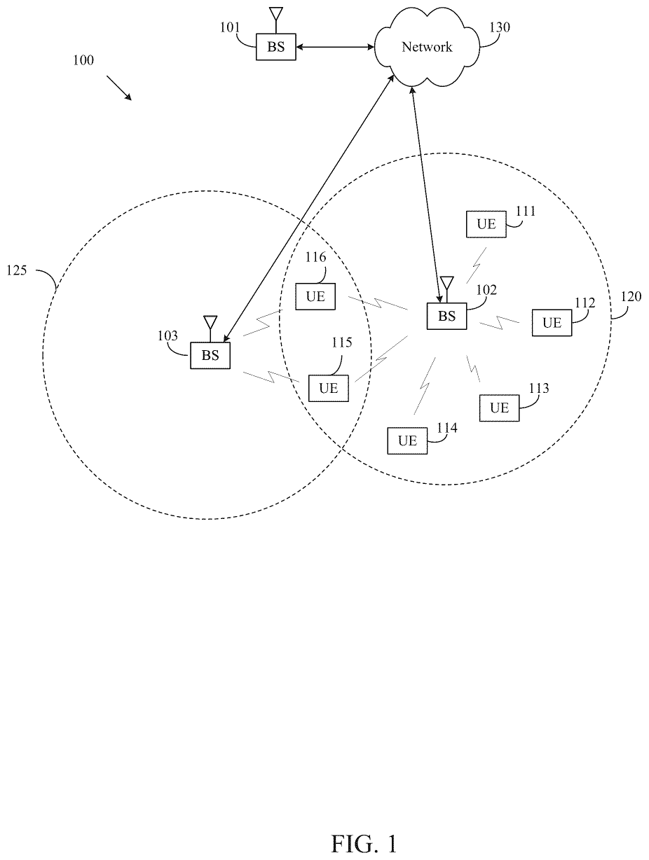

FIG. 1 through FIG. 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated into the present disclosure as if fully set forth herein: 3GPP TS 38.211 v17.5.0, “NR; Physical channels and modulation”; 3GPP TS 38.212 v17.5.0, “NR; Multiplexing and channel coding”; 3GPP TS 38.213 v17.6.0, “NR; Physical layer procedures for control”; 3GPP TS 38.214 v17.6.0, “NR; Physical layer procedures for data”; 3GPP TS 38.331 v17.5.0, “NR; Radio Resource Control (RRC) protocol specification”; and 3GPP TS 38.321 v17.5.0, “NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 includes circuitry, programing, or a combination thereof, to support a UE-initiated cell operation adaptation in wireless communication systems. Also, as described in more detail below, one or more of the UEs 111-116 includes circuitry, programing, or a combination thereof, to perform a UE-initiated cell operation adaptation in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

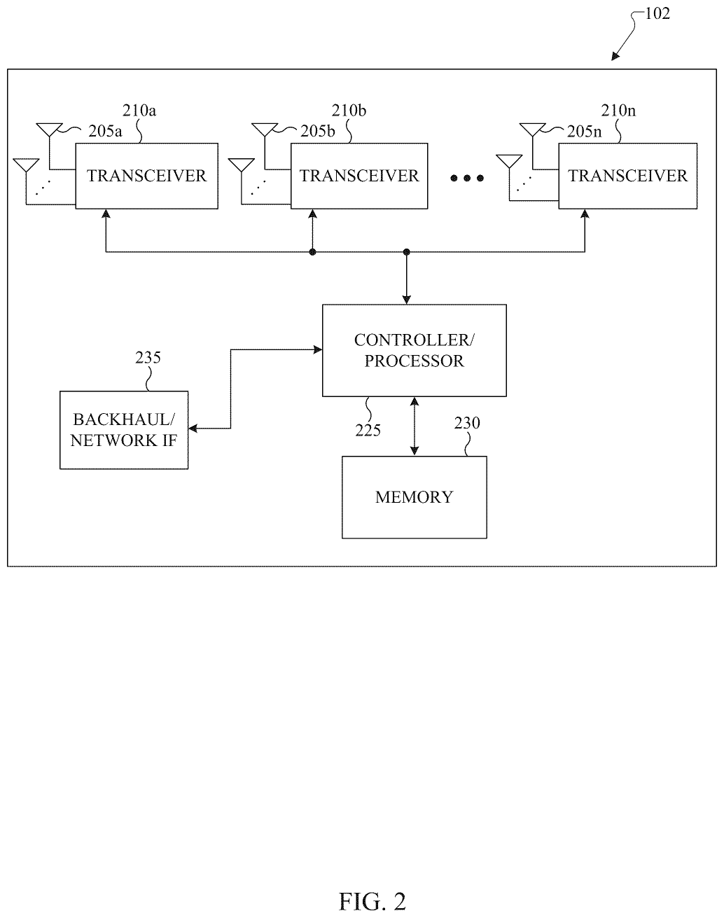

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a UE-initiated cell operation adaptation in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

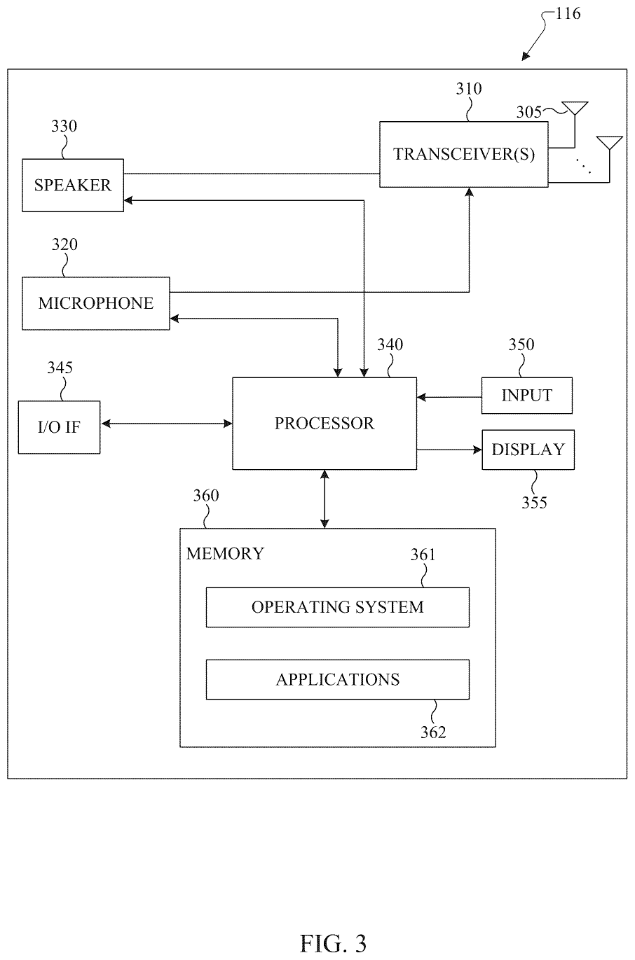

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can move data into or out of the memory 360 as required by an executing process. In some embodiments, the processor 340 is configured perform a UE-initiated cell operation adaptation in wireless communication systems. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

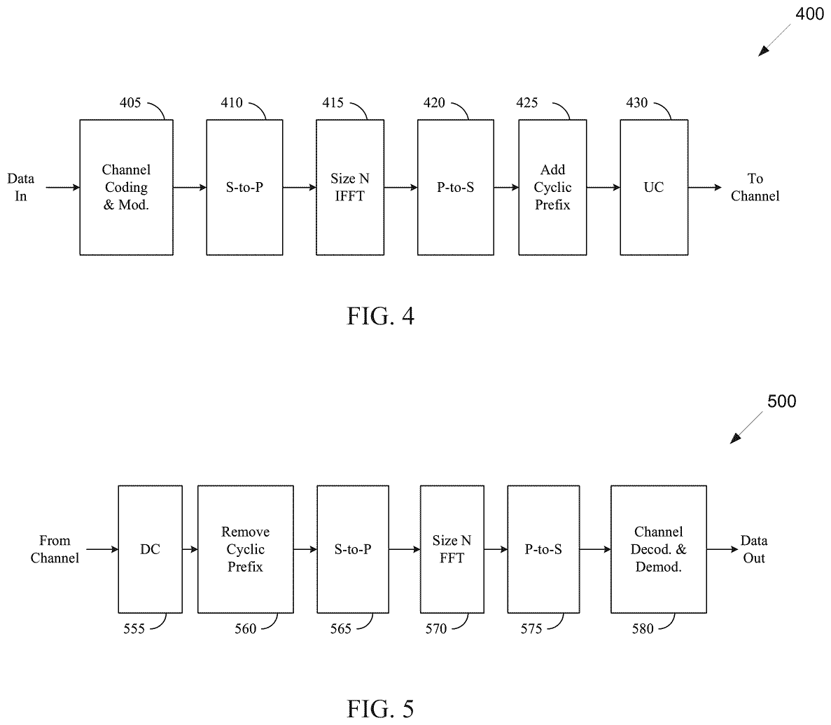

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to perform a UE-initiated cell operation adaptation in wireless communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

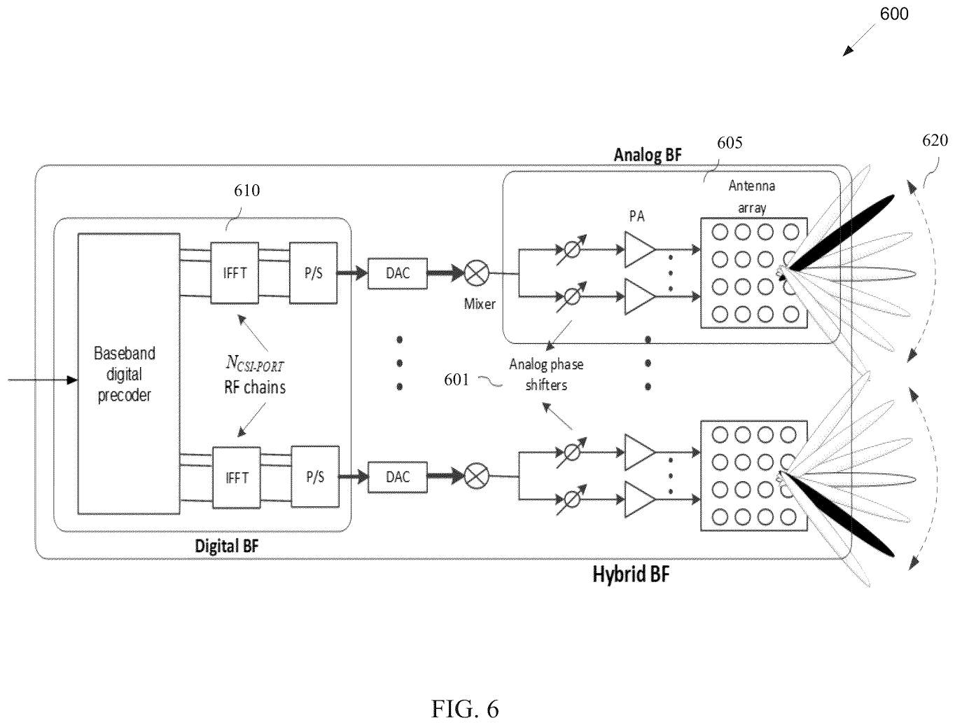

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

MIMO technologies have a key role in boosting system throughput both in NR and LTE and such a role will continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) “CLASS A” CSI reporting that corresponds to non-precoded CSI-RS, 2) “CLASS B” CSI reporting with K=1 CSI-RS resource that corresponds to UE-specific beamformed CSI-RS, and 3) “CLASS B” reporting with K>1 CSI-RS resources that corresponds to cell-specific beamformed CSI-RS. For non-precoded (NP) CSI-RS, a cell-specific one-to-one mapping between CSI-RS port and TXRU is utilized.

Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and hence do not provide cell-wide coverage, and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1<T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For MU-MIMO, in particular, availability of accurate CSI is necessary in order to guarantee robust MU performance and avoid interference among transmissions to different UEs. For TDD systems, CSI can be acquired using SRS transmissions from UEs by relying on DL/UL channel reciprocity. For FDD systems, a gNB can acquire CSI by transmitting CSI-RS and obtaining corresponding CSI reports from UEs. A CSI reporting framework can be “implicit” in the form of CQI/PMI/RI, and possibly CSI-RS resource indicator (CRI), as derived from a codebook assuming SU transmission from eNB. Because of the inherent SU assumption while deriving CSI, implicit CSI report is inadequate for MU transmissions. For MU-centric operation, a high-resolution Type-II codebook, in addition to low resolution Type-I codebook, can be used.

CSI refers to any of CRI, RI, length indicator (LI), PMI, CQI, reference signal received power (RSRP), or signal to interference noise ratio (SINR).

Present networks have limited capability to adapt an operation state in one or more of time/frequency/spatial/power domains. For example, in NR, there are transmissions or receptions on a cell by a serving gNB that are always expected by UEs, such as transmissions of synchronization signals/physical broadcast channel (SS/PBCH) blocks, or of system information, or of CSI-RS indicated by higher layers, or receptions of physical random access channel (PRACH) or sounding reference signal (SRS) indicated by higher layers.

Reconfiguration of a NW operation state involves higher layer signaling by a system information block (SIB) or by UE-specific RRC. That is a slow process and requires substantial signaling overhead, particularly for UE-specific RRC signaling. For example, it is currently not practical or possible for a network in typical deployments to enter an energy saving operation state where the network does not transmit or receive due to low traffic on a cell as, in order to obtain material energy savings, the network needs to suspend transmissions or receptions for several tens of milliseconds and preferably for even longer time periods. A similar inability exists for suspending transmission or receptions on a cell for shorter time periods as a serving gNB may need to frequently transmit SS/PBCH blocks on the cell, such as every 5 msec or every 20 msec and, in time division duplex (TDD) systems with UL-DL configurations having few UL symbols in a period, the serving gNB may need to receive PRACH or SRS on the cell in most UL symbols in a period.

Due to the above reasons, adaptation of an operation state on a cell is typically over long time periods, such as for off-peak hours when an amount of served traffic is small and for peak hours when an amount of served traffic is large. Therefore, a capability of a gNB to improve service by fast adaptation of an operation state to the traffic types and load on a cell, or to save energy by switching to an operation state that requires less energy consumption when an impact on service quality may be limited or none on a cell, is currently limited as there are no procedures for a serving gNB to perform fast adaptation of an operation state with small signaling overhead while simultaneously informing all UEs of the operation state for a cell.

It is also beneficial to support a gradual transition of operation states on a cell between a maximum state where the cell operates at its maximum capability in one or more of a time/frequency/spatial/power domain and a minimum state where the cell operates at its minimum capability, or the cell enters a sleep mode. That may allow continuation of service while the cell transitions from a state with larger utilization of time/frequency/spatial/power resources to a state with lower utilization of such resources and the reverse as UEs can obtain time/frequency synchronization and automatic gain control (AGC) alignments, perform measurements and provide CSI reports or transmit SRS prior to scheduling of PDSCH receptions or PUSCH transmissions.

In order to enable a gNB to operate a cell on sleep state and save energy while minimizing an impact on served UEs on the cell, the gNB can apply discontinued transmissions (cell DTX) or discontinued receptions (cell DRX) on the cell, as an example operation state. A UE can be informed of corresponding cell DTX/DRX configurations for a cell such that the UE can operate accordingly and avoid power consumption when the cell is in a dormant state (cell DTX/DRX). By turning off all or a part of a transmission chain and pausing transmission during the cell DTX, the gNB can reduce energy consumption for standby when there is little to no traffic on a cell. For cell DTX, a UE may assume that all transmissions from a serving gNB on the cell are suspended or the UE may assume that some signals, such as PSS or SSS for maintaining synchronization, remain present during cell DTX. For example, the UE may not monitor PDCCH providing dynamic grants for PDSCH receptions or may not receive semi-persistent scheduled (SPS) PDSCH during cell DTX off-duration.

By turning off all or a part of receiver chain and pausing receptions during the cell DRX, the gNB can reduce energy consumption for standby on a cell when there is little to no traffic on the cell. For cell DRX, a UE may assume that all transmissions from the UE on a cell are suspended or may assume that some transmissions, such as ones required for initial access such as PRACH, are allowed during a cell DRX duration. During cell DRX off-duration, for example, the UE may not transmit configured grant (CG) PUSCH or a PUCCH with a scheduling request (SR) or a CSI report.

A cell DTX or a cell DRX is an example of an operation state on a cell having discontinued transmission or reception on the cell during off-duration, respectively. For example, the UE may not monitor PDCCH providing dynamic grants for PDSCH receptions or may not receive semi-persistent scheduled (SPS) PDSCH during cell DTX off-duration. During cell DRX off-duration, the UE may not transmit configured grant (CG) PUSCH or a PUCCH with a scheduling request (SR) or a CSI report. Some operation states can be defined such that cell DTX or cell DRX is not used, and the UE assumes continuous transmission or reception on the cell, i.e., normal operation.

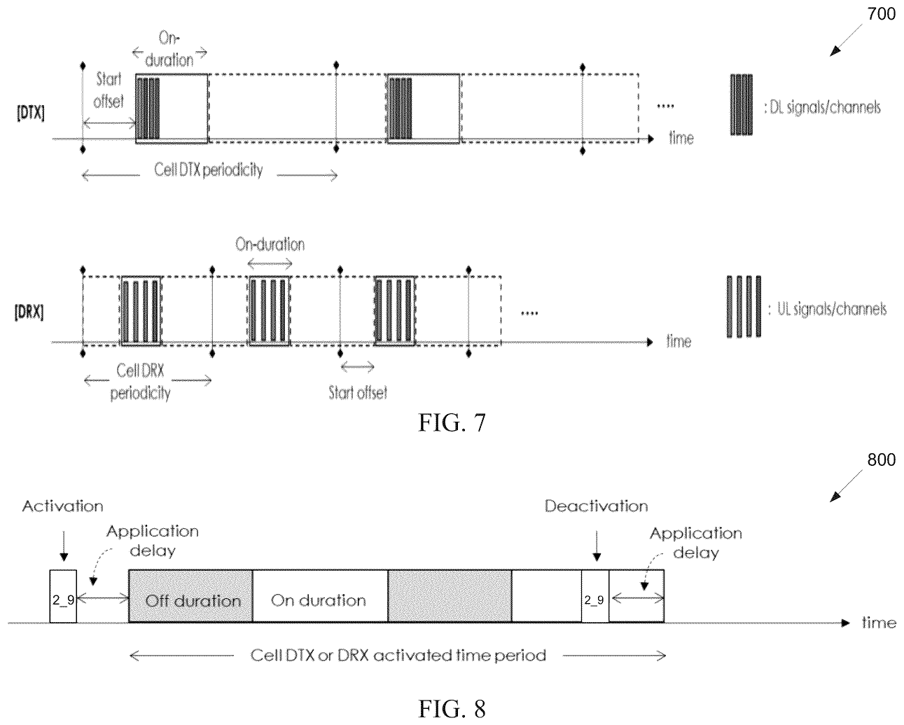

FIG. 7 illustrates an example of a cell DTX/DRX 700 according to various embodiments of the present disclosure. An embodiment of the cell DTX/DRX 700 shown in FIG. 7 is for illustration only.

As illustrated in FIG. 7, cell DTX/DRX can be configured via at least a periodicity, a start slot/offset, and an on-duration. A UE assumes that all transmissions/receptions by the gNB on a cell are enabled during the DTX/DRX on-duration, respectively. The configurations and operations of cell DTX and cell DRX can be linked or can be separate, for example depending on DL/UL traffic characteristics on the cell.

The general principle for adapting operation states on a cell includes a serving gNB indicating to a UE a set of operation states on the cell by higher layer signaling, such as by a SIB or UE-specific RRC signaling, and transmitting a PDCCH that provides a DCI format (DCI format 2_9) indicating one or more indexes from the set of operation states on the cell for the UE to determine an update of operation states.

FIG. 8 illustrates an example of a cell DTX/DRX activation/deactivation on a cell 800 according to various embodiments of the present disclosure. An embodiment of the cell DTX/DRX activation/deactivation on a cell 800 shown in FIG. 8 is for illustration only.

FIG. 8 illustrates an example of cell DTX/DRX activation/deactivation on a cell using DCI format 2_9. FIG. 8 illustrates an activation of a cell DTX or cell DRX upon receiving PDCCH providing DCI format 2_9 indicating activation after an application delay and deactivation of a cell DTX or cell DRX upon receiving PDCCH providing DCI format 2_9 indicating deactivation after an application delay. The application delay from the reception of PDCCH providing DCI format 2_9 until the activation or deactivation of an operation state on a cell can be predefined or provided to the UE via higher layer signaling.

Network operation parameters for a transmission or reception on a cell can be in one or more of a power, spatial, time, or frequency domain.

For example, in a power domain, a first NW operation state for a cell can be associated with a first value of parameter ss-PBCH-BlockPower providing an average energy per resource element (EPRE) with SSS in dBm, and a second NW operation state can be associated with a second value of a parameter ss-PBCH-BlockPower. For example, first and second NW operation states for a cell can be respectively associated with first and second values of parameter powerControlOffsetSS that provides a power offset (in dB) of non-zero power (NZP) CSI-RS RE to SSS RE. For example, first and second NW operation states for a cell can be respectively associated with first and second values of parameter powerControlOffset that provides a power offset (in dB) of PDSCH RE to NZP CSI-RS RE.

For example, in a frequency domain, first and second NW operation states for a cell can be respectively associated with first and second values of a parameter locationAndBandwidth that indicates a frequency domain location and a bandwidth for receptions or transmissions by a UE on the cell. For example, first and second NW operation states for a cell can be respectively associated with first and second values of a parameter BWP-Id for an active DL BWP or an active UL on the cell. For example, first and second NW operation states can be respectively associated with first and second values of a list of cells for active transmission and reception. The cells can be serving cells or non-serving cells for example in case of mobility.

For example, in a spatial domain, first and second NW operation states for a cell can be respectively associated with first and second values of a parameter maxMIMO-Layers that indicates a maximum number of MIMO layers to be used for PDSCH receptions by a UE in the associated active DL BWP of the cell, or with first and second values of a parameter nrOfAntennaPorts that indicates a number of antenna ports to be used for codebook determination for PDSCH receptions on the cell, or with first and second values of a parameter activeCoresetPoolIndex for coresetPoolIndex values for PDCCH reception in corresponding CORESETs on the cell and the UE can skip PDCCH receptions in a CORESET with a coresetPoolIndex value that is not indicated by activeCoresetPoolIndex. For example, first and second NW operation states for a cell can be respectively associated with first and second values of an antenna port subset that indicates a list of active antenna ports for CSI calculation and other associated parameters such as codebook subset restriction, rank restriction, the logical antenna size in a two-dimension, number of antenna ports, and a list of CSI-RS resources, etc., for the cell.

For example, in a time domain, first and second NW operation states for a cell can be respectively associated with first and second values of a parameter ssb-PeriodicityServingCell that indicates a transmission periodicity in milliseconds for SS/PBCH blocks on the cell, or with first and second values of a parameter ssb-PositionsInBurst that indicates time domain positions of SS/PBCH blocks in a SS/PBCH block transmission burst on the cell, or with first and second values of a parameter groupPresence that indicates groups of SS/PBCH blocks, such as groups of four SS/PBCH blocks with consecutive indexes, that are transmitted on the cell. For example, first and second NW operation states for a cell can be respectively associated with first and second values of a time pattern, e.g., in terms of periodicity, on-duration, start offset, etc., that indicates cell discontinuous transmission (DTX) or cell discontinuous reception (DRX) for the cell.

SSB/SIB transmission intervals have a fixed periodicity. Such a fixed SSB periodicity and subsequent SIBs, such as SIB1 scheduled by MIB and other SIBs scheduled by SIB1, limits the flexibility of network adaptation and the network energy saving gain. Therefore, there is a need to define procedures and methods for a UE to request a serving gNB to provide SSB and/or SIBs, e.g., by transmitting wake-up signal (WUS), and for the UE to receive SSB and/or SIB transmitted by the serving gNB based on demand. The WUS transmission decisions may not be arbitrarily made by UEs. Therefore, there is another need to define procedures and methods for a UE to decide WUS transmission based on certain triggering conditions.

The WUS transmissions by UEs need to be regulated to certain time occasions in certain time durations in order not to increase the network energy spending in monitoring WUS as the cell may operate at its minimum capability or in a sleep mode. Therefore, there is a need to define procedures and methods for a UE to determine valid time occasions for transmitting WUS. Furthermore, there is a need to define procedures and methods for a UE to generate WUS signal and to transmit the generated signal in accordance with the transmission parameters provided by the serving gNB.

After transmitting the WUS, the UE monitors a response and/or SSB/SIB from the serving gNB in response to the reception of the WUS. If the response and/or SSB/SIB is not received after monitoring for a certain time duration, the UE needs to determine whether the WUS transmission was successful or not. Therefore, there is a need to define procedures and methods for a UE to monitor a WUS response from the serving gNB for a certain configured monitoring time window and to determine whether the WUS transmission was successful or not.

The WUS transmission may fail at its initial attempt, i.e., no response received from the serving gNB, and, therefore, the WUS may need to be retransmitted by the UE. In retransmitting the WUS, the success probability can be enhanced by ramping up the WUS transmission power, while the retransmission attempts need to be regulated to avoid a large number of WUS transmissions and possible collisions among UEs. Therefore, there is a need to define procedures and methods for a UE to determine the WUS transmission power for the first and the subsequent transmission attempts. Furthermore, there is a need to define procedures and methods for a UE to perform WUS retransmissions in accordance with the retransmission parameters provided by the serving gNB.

The present disclosure relates to a communication system. The present disclosure relates to defining functionalities and procedures for adapting availability of SSB and/or SIBs based on demand in order to support network energy savings for the cell.

The present disclosure further relates to defining procedures and methods for a UE to request a serving gNB to provide SSB and/or SIBs, e.g., by transmitting WUS, and for the UE to receive SSB and/or SIB transmitted by the serving gNB based on demand.

The present disclosure further relates to defining procedures and methods for a UE to decide WUS transmission based on certain triggering conditions.

The present disclosure additionally relates to defining procedures and methods for a UE to determine valid time occasions for transmitting WUS.

The present disclosure further additionally relates to defining procedures and methods for a UE to generate WUS signal and to transmit the generated signal in accordance with the transmission parameters provided by the serving gNB.

The present disclosure also relates to defining procedures and methods for a UE to monitor a WUS response from the serving gNB for a certain configured monitoring time window and to determine whether the WUS transmission was successful or not.

The present disclosure further relates to defining procedures and methods for a UE to determine the WUS transmission power for the first and the subsequent transmission attempts.

The present disclosure additionally relates to defining procedures and methods for a UE to perform WUS retransmissions in accordance with the retransmission parameters provided by the serving gNB.

Embodiments of the disclosure for adapting availability of SSB and/or SIBs based on demand, for example in order to support network energy savings for the cell, are summarized in the following and are fully elaborated further below: (1) method and apparatus for defining procedures and methods for a UE to request a serving gNB to provide SSB and/or SIBs, e.g., by transmitting WUS, and for the UE to receive SSB and/or SIB transmitted by the serving gNB based on demand; (2) method and apparatus for defining procedures and methods for a UE to decide WUS transmission based on certain triggering conditions, (3) method and apparatus for defining procedures and methods for a UE to determine valid time occasions for transmitting WUS, (4) method and apparatus for defining procedures and methods for a UE to generate WUS signal and to transmit the generated signal in accordance with the transmission parameters provided by the serving gNB, (5) method and apparatus for defining procedures and methods for a UE to monitor a WUS response from the serving gNB for a certain configured monitoring time window and to determine whether the WUS transmission was successful or not, (6) method and apparatus for defining procedures and methods for a UE to determine the WUS transmission power for the first and the subsequent transmission attempts, and (7) method and apparatus for defining procedures and methods for a UE to perform WUS retransmissions in accordance with the retransmission parameters provided by the serving gNB.

The general principle for a UE-initiated cell operation adaptation includes a UE transmitting WUS when certain triggering conditions are met and a serving gNB transmitting a message in response to the reception of the WUS. The serving gNB may respond by transmitting SSB and/or a PDCCH providing a certain DCI format scheduling, e.g., scrambled by SI-RNTI or RA-RNTI, a PDSCH providing a response message.

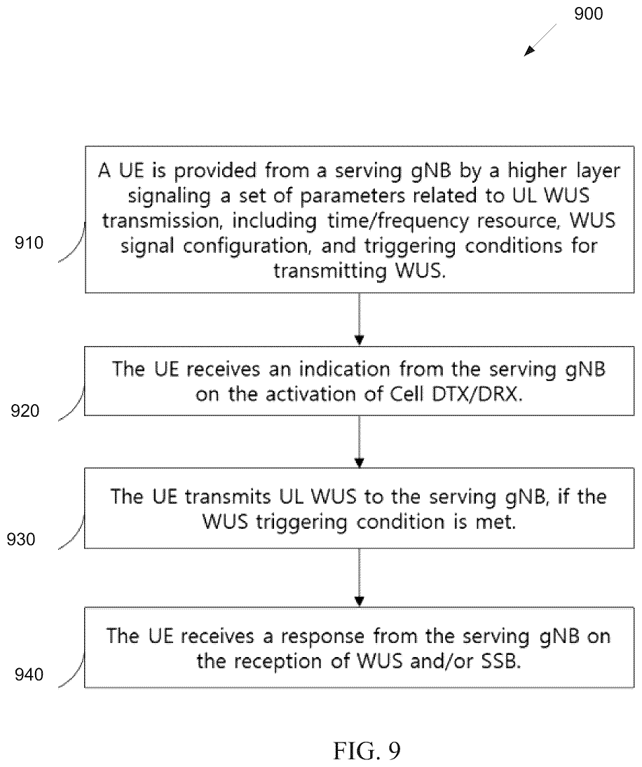

FIG. 9 illustrates a flowchart of a UE method 900 for transmitting WUS according to various embodiments of the present disclosure. The method 900 as may be performed by a UE (e.g., UE, 111-116 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

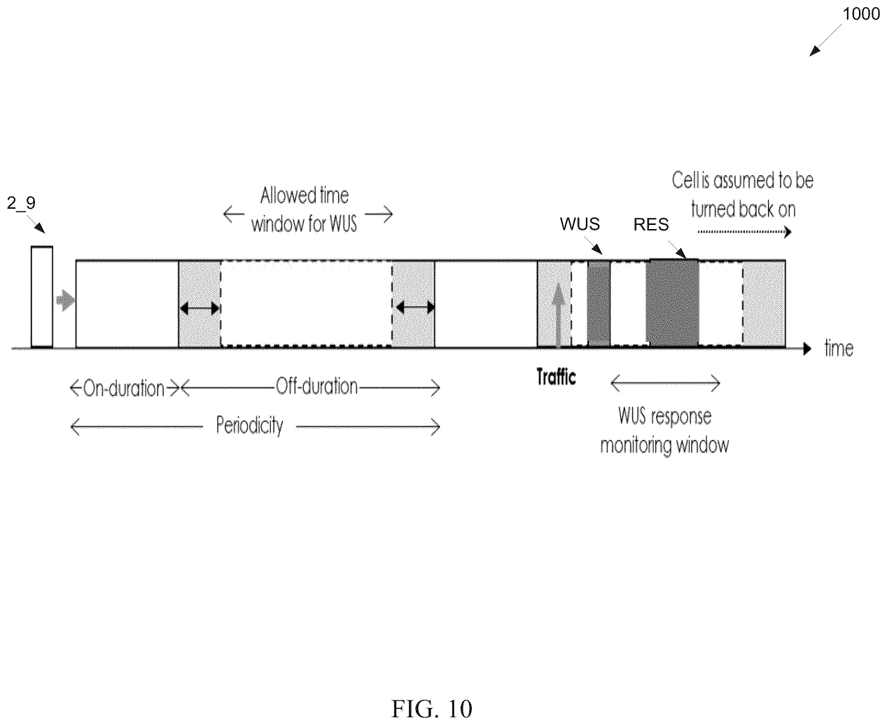

FIG. 10 illustrates an example of UE and gNB for transmission and response 1000 according to various embodiments of the present disclosure. The UE and gNB for transmission and response 1000 as may be performed by a UE (e.g., 111-116 as illustrated in FIG. 1) and a base station (e.g., 101-103 as illustrated in FIG. 1). An embodiment of the UE and gNB for transmission and response 1000 shown in FIG. 10 is for illustration only.

As illustrated in FIG. 9, a UE is provided from a serving gNB by a higher layer signaling a set of parameters related to UL WUS transmission, including time/frequency resource, WUS signal configuration, and triggering conditions for transmitting WUS in step 910. The higher layer signaling can be a SIB or UE-specific RRC signaling. The UE receives an indication from the serving gNB on the activation of cell DTX/DRX in step 920.

As illustrated in FIG. 10, a cell DTX/DRX is activated upon receiving PDCCH providing DCI format 2_9 indicating activation after an application delay. As an example, the transmission of WUS may be allowed for UEs when the cell is in cell DTX/DRX off-durations.

The UE transmits WUS to the serving gNB, if the WUS triggering condition is met in step 930. The triggering condition may be provided in terms of traffic such as arrivals of certain traffic types, logical channels, logical channel groups, buffered traffic volume, and latency requirement of newly arrived packets. The UE receives a response from the serving gNB on the reception of WUS and/or SSB 940. The UE expects to receive a response from the serving gNB within a WUS response monitoring window, which may be predefined in the specifications of the system operation or indicated to the UE via higher layer signaling such as SIB or UE-specific RRC in number of slots or ms, as illustrated in FIG. 10.

A UE is provided parameters for time domain resources for WUS transmission such as periodicity and offset defining periodic WUS transmission occasions. For example, a UE is provided from a serving gNB by a higher layer signaling, WUS_{periodicity} and WUS_{offset}, such that the UE may potentially transmit WUS at time slots, WUSₛₗₒₜ, satisfying the following equation: (SFN·Nₛₗₒₜ^{frame,μ}+WUSₛₗₒₜ−WUS_{offset}) mod WUS_{periodicity}=0 where: Nₛₗₒₜ^{frame,μ} is the number of slots within a frame for a given sub-carrier spacing configuration numerology μ; and WUS_{offset} and WUS_{periodicity} are provided to UE in number of slots.

While the above equation defines periodic occasions for potential WUS transmissions, the actual WUS transmissions by a UE may be restricted to a certain time duration, such as cell DTX and/or DRX off-durations, during which the cell is in dormancy. Such a restriction helps to regulate the UE WUS transmissions when normal SSBs and SIBs are transmitted in a regular basis.

In one example, a UE is provided an indication from the serving gNB on the allowance of WUS transmission in one or more of the following scenarios: (1) WUS occasions falling into cell DTX on-durations; (2) WUS occasions falling into cell DTX off-durations; (3) WUS occasions falling into either cell DTX on-durations or off-durations, i.e., time duration when cell DTX is activated; (4) WUS occasions falling into a time duration when cell DTX is deactivated; (5) WUS occasions falling into cell DRX on-durations; (6) WUS occasions falling into cell DRX off-durations; (7) WUS occasions falling into either cell DRX on-durations or off-durations, i.e., time duration when cell DRX is activated; (8) WUS occasions falling into a time duration when cell DRX is deactivated; (9) WUS occasions falling into both cell DTX on-durations and cell DRX on-durations; (10) WUS occasions falling into both cell DTX on-durations and cell DRX off-durations; (11) WUS occasions falling into both cell DTX off-durations and cell DRX on-durations; (12) WUS occasions falling into both cell DTX off-durations and cell DRX off-durations; (13) WUS occasions falling into a time duration when either one of cell DTX or cell DRX is activated; (14) WUS occasions falling into a time duration when both cell DTX and cell DRX are activated; and (15) WUS occasions falling into a time duration when both cell DTX and cell DRX are deactivated.

Alternatively, the allowance of WUS transmissions in one or more of the above scenarios may be predefined in the specifications of the system operation.

For time durations allowed for WUS transmission, a UE may be additionally provided with one or more offset values further restricting the allowed time duration for WUS transmissions.

The example as illustrated in FIG. 10 shows the scenario when the WUS transmission is allowed during cell DTX/DRX off-durations. The WUS transmission may be further restricted in the beginning and/or in the end of the cell DTX/DRX off-durations during which WUS transmission is not allowed. Such restrictions may help to regulate UE WUS transmissions right after a normal SSB transmission in the preceding on-duration or right before a normal SSB transmission in the following on-duration.

The one or more offset values to restrict the beginning and/or the end of a certain time duration, which can be any duration indicated or specified to be allowed for WUS transmission and not necessarily cell DTX/DRX off-durations as exemplified, can be predefined in the specifications of system operations or provided to a UE via higher layer signaling such as SIB or UE-specific RRC. If indicated, the offset values can be provided to a UE in number of symbols, slots, or in an integer multiple of SSB periodicity, which can be a periodicity of cell-defining SSB if there are more than one SSBs transmitted on the cell.

A UE may be also provided from a serving gNB a starting symbol position and a duration, e.g., a number of symbols, for WUS transmission within a slot identified as WUS occasions. The starting symbol position and the duration of WUS transmission can be provided to a UE via higher layer signaling such as SIB or UE-specific RRC. When the WUS is based on PUCCH such as SR, as one example, such parameters can be explicitly provided in a PUCCH resource configuration indicated by startingSymbolIndex and nrofSymbols. When the WUS is based on PRACH preambles, as another example, such parameters can be implicitly indicated by prach-ConfigurationIndex provided in a RACH configuration.

In one example, a UE may be provided with more than one WUS occasion configurations having possibly different WUS_{offset} and WUS_{periodicity} values. The respective WUS occasion configurations may be associated with different triggering conditions for prioritized access to WUS transmission. For instance, a WUS occasion configuration with more frequent transmission occasions can be associated with a certain set of prioritized logical channels or logical channel groups.

A UE is provided parameters for frequency domain resources for WUS transmission from a serving gNB. In one example, the UE is also provided parameters for frequency domain resources for WUS transmission such as a certain frequency range for WUS transmission, including a starting PRB index, startPRB, and a number of PRBs, nrofPRBs. In another example, a UE is indicated one or more indexes of serving cells for which the WUS transmissions are allowed. If the UE is configured with more than one serving cell groups, the UE is indicated one or more indexes of serving cell groups and one or more indexes of serving cells within a serving cell group for which the WUS transmissions are allowed. Furthermore, the UE can be provided indexes of UL and/or DL BWPs for transmitting WUS and receiving response messages from the serving gNB, respectively.

A UE may be also provided parameters for frequency hopping in transmitting WUS. For instance, the UE can be provided with an indicator enabling or disabling frequency hopping, i.e., frequencyHopping. The frequencyHopping may also indicate whether the hopping is for intra-slot or inter-slot hopping. Furthermore, the UE can be provided with secondHopPRB indicating an index of first PRB after frequency hopping of WUS. This value is applicable for intra-slot frequency hopping or inter-slot frequency hopping.

A UE is provided from a serving gNB by a higher layer signaling the WUS triggering conditions such that the UE transmits WUS to the serving gNB in a valid WUS transmission occasion.

In one example, a triggering condition is related to a traffic arrival. For instance, a UE is provided with one or more indexes of logical channels, or logical channel groups (LCGs), and the WUS transmission is triggered at the UE when traffics for those indicated logical channels or LCGs arrive during the time duration allowed for WUS transmission. There may be additional parameters defined or signaled to the UE in determining traffic-based WUS triggering conditions. In one example, buffer threshold values and/or time delays are further associated with one or more logical channels or LCGs such that WUS transmission is triggered when the amount of buffered traffic of the logical channel or LCG exceeds the associated buffer threshold value and/or the packet delay of the logical channel or LCG exceeds the associated time delay value.

The packet delay can be, for instance, measured as the delay of the head-of-the-line packet in the buffer for the corresponding logical channel or in any of the buffers for the corresponding LCG. In another example, the triggering condition is such that if there is any new traffic arrival for any logical channel or LCG during the time duration allowed for WUS transmission, the WUS transmission is triggered at the UE.

In another example, a triggering condition is related to a synchronization accuracy at a UE. For instance, if the time elapsed since the last reception of SSB on the cell exceeds the provided timer value, e.g., SyncTimer, the WUS transmission is triggered at the UE. This SyncTimer can be provided in slots, subframes, ms, or an integer multiple of SSB periodicity on the cell.

In another example, a triggering condition is related to the time elapsed since the last reception of a certain signal or a channel, e.g., DCI 2_9. For instance, if the time elapsed since the last reception of DCI 2_9 exceeds the provided DCI 2_9-timer, the WUS transmission is triggered at the UE. This DCI 2_9-timer can be provided in slots, subframes, ms, or an integer multiple of PDCCH monitoring periodicity associated with DCI 2_9. This triggering condition may help to recover a UE who missed DCI 2_9 in one or more of the previous DCI 2_9 transmission occasions.

The one or more of the above criteria can jointly define WUS triggering conditions.

The UE is provided parameters for WUS signal configuration, which includes a type of WUS. An UL WUS may be based on one or more of existing signals or channels such as scheduling request (SR) using PUCCH, PRACH preambles, and SRS. The WUS signal type can be predefined in the specifications of the system operation or indicated to the UE via higher layer signaling such as SIB or UE-specific RRC signaling.

In one example, WUS can be based on PUCCH formats. For instance, PUCCH Format 0 or PUCCH Format 1 can be used as UL WUS, while other PUCCH formats such as Format 2, 3, 4, can be also used for WUS. When PUCCH Format 0 is used for WUS, it occupies 1 RB in frequency domain and either 1 or 2 symbols in time domain, with possible frequency hopping when 2 symbols are used. The cyclic shifts when PUCCH Format 0 is used for WUS can be predefined in the specifications of the system operation or indicated to the UE, along with startingSymbolIndex within a slot, nrofSymbols, startingPRB, and secondHopPRB if frequency hopping is enabled. In another example, frequency hopping is always applied when PUCCH Format 0 with 2 symbols is used for WUS. When PUCCH Format 1 is used for WUS, it occupies 1 RB in frequency domain and between 4 and 14 symbols in time domain.

In one example, frequency hopping between the first subset of symbols and the second subset of symbols may be indicated to the UE via higher layer signaling. Alternatively, the frequency hopping may be always applied when PUCCH Format 1 is used for WUS. When PUCCH Format 1 is used, a particular modulation symbol is dedicated for the purpose of WUS, e.g., either 0 or 1 for BPSK or one of four constellations for QPSK. The cyclic shifts when PUCCH Format 1 is used for WUS can be predefined in the specifications of the system operation or indicated to the UE via higher layer signaling, along with startingSymbolIndex within a slot, nrofSymbols, startingPRB, secondHopPRB if frequency 1 hopping is enabled, and timeDomainOCC. In one example, existing SR configurations, such as SchedulingRequestConfig and SchedulingRequestResourceConfig, can be reused for WUS configuration.

A UE can be provided from a serving gNB an indicator describing that the corresponding SR configuration is the purpose of WUS. When SR-based WUS is used, the SR for the purpose of WUS may be allowed to be transmitted at occasions falling in a cell DTX/DRX off-durations, while other general SR transmissions may not be allowed during cell DTX/DRX off-durations.

In one example, the SR configuration may explicitly indicate whether the corresponding SR can be transmitted during cell DTX/DRX off-durations or not.

In another example, WUS can be based on SRS. The existing SRS-ResourceSet configuration can be reused for WUS configuration. The usage field in the SRS-ResourceSet configuration may indicate WUS in addition to the list of existing legacy usages. For SRS based WUS, only semi-persistent and periodic SRS resourceTypes are applicable while aperiodic SRS is not applicable for WUS. When SRS-based WUS is used, the SRS for the purpose of WUS may be allowed to be transmitted at occasions falling in a cell DTX/DRX off-durations, while SRS transmissions for other existing usages, such as beamManagement, codebook, nonCodebook, and antennaSwitching, may not be allowed during cell DTX/DRX off-durations. In one example, the SRS configuration may explicitly indicate whether the corresponding SRS can be transmitted during cell DTX/DRX off-durations or not.

In yet another example, WUS can be based on PRACH preambles. In one example, a certain set of preambles, i.e., root sequences and/or cyclic shifts for a given length-L sequence, can be assigned for a dedicated purpose of WUS transmission. A dedicated set of preambles can be predefined in the specifications of the system operation or indicated to the UE via higher layer signaling such as SIB or UE-specific RRC.

A UE transmitting WUS according to a set of parameters related to WUS transmission provided by the serving gNB. The set of parameters include: (1) WUS-transMax: the maximum number of WUS transmissions allowed for a UE for a given series of WUS transmissions, i.e., initial transmission and subsequent retransmissions, or for a given WUS transmission time window; (2) WUS-prohibitTimer: the minimum time between consecutive WUS transmissions, i.e., a UE cannot transmit another WUS within the WUS-prohibitTimer starting from the previous WUS transmission; (3) WUS transmission power control parameters such as parameters for determining initial transmission power value and for determining transmission power values for subsequent retransmissions with power ramping; and (4) WUS response (WR) monitoring window: time window during which a UE expects to receive a response and/or SSB from the serving gNB after transmitting WUS. If the UE does not receive a response and/or SSB/SIB from the serving gNB during WR monitoring window, the UE attempts WUS retransmissions.

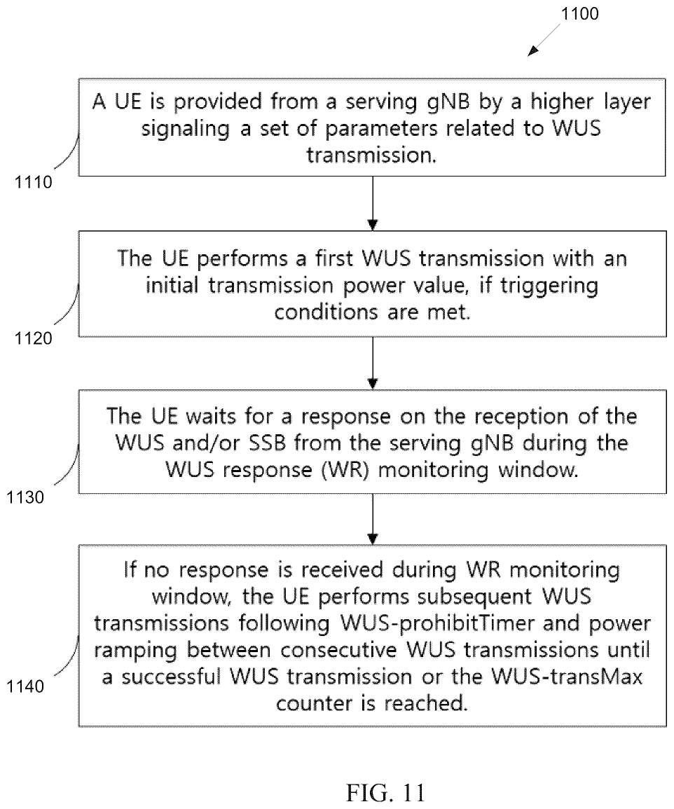

FIG. 11 illustrates a flowchart of UE method 1100 for transmitting WUS based on WUS transmission parameters according to various embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, in step 1110, a UE is provided from a serving gNB by higher layer signaling a set of parameters related to WUS transmission. In step 1120, the UE performs a first WUS transmission with an initial transmission power value, if triggering conditions are met. In step 1130, the UE waits for a response on the reception of the WUS and/or SSB/SIB from the serving gNB during the WUS response (WR) monitoring windows. In step 1140, if no response is received during WR monitoring window, the UE performs subsequent WUS transmissions following WUS-prohibitTimer and power ramping between consecutive WUS transmission until a successful WUS transmission or the WUS-transMax counter is reached.

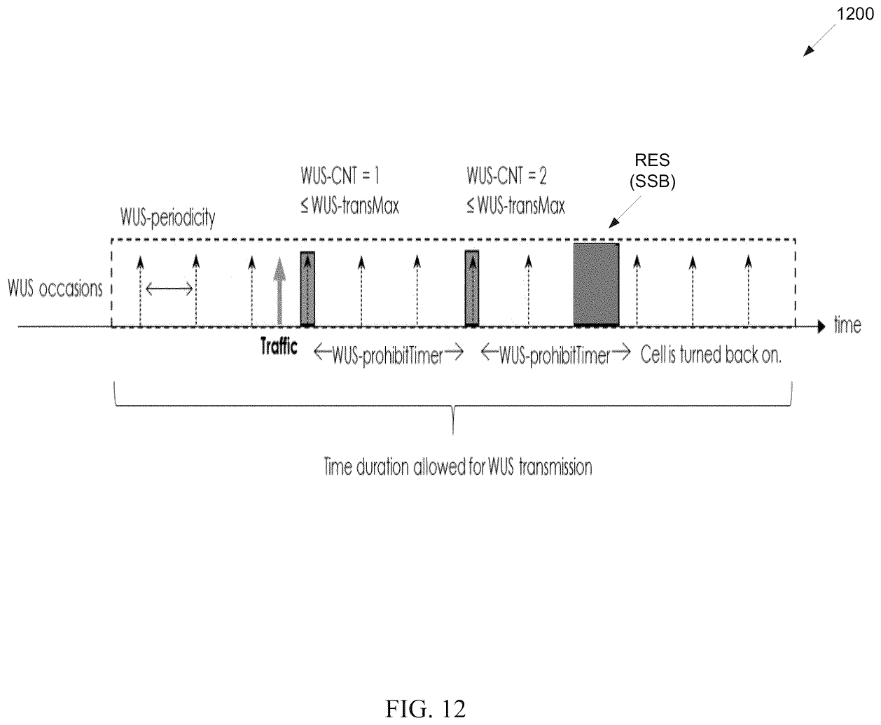

FIG. 12 illustrates an example of UE for transmitting WUS based on WUS transmission parameters 1200 according to various embodiments of the present disclosure. An embodiment of the UE for transmitting WUS based on WUS transmission parameters 1200 shown in FIG. 12 is for illustration only.

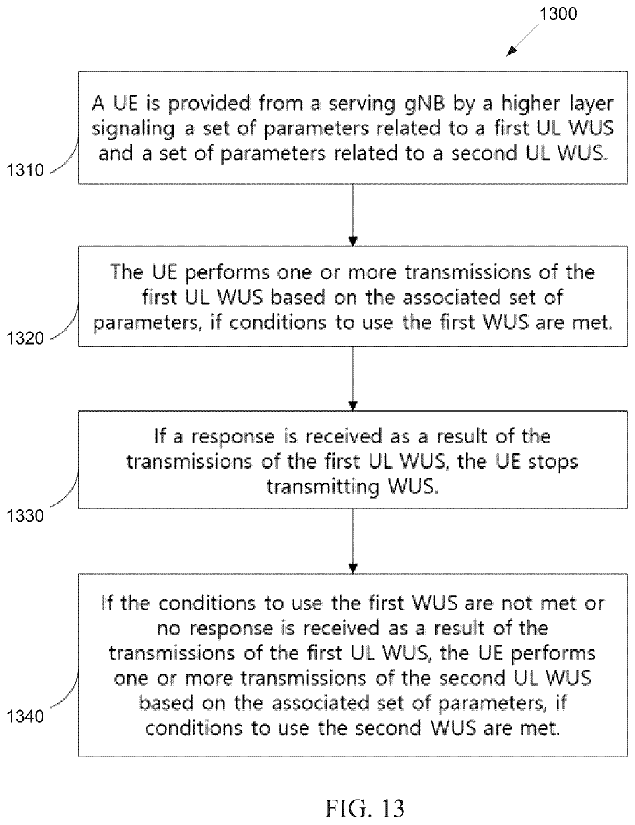

FIG. 13 illustrates a flowchart of UE method 1300 for switching between a first UL WUS and a second UL WUS according to various embodiments of the present disclosure. The method 1300 as may be performed by a UE (e.g., 111-116 as illustrated in FIG. 1). An embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

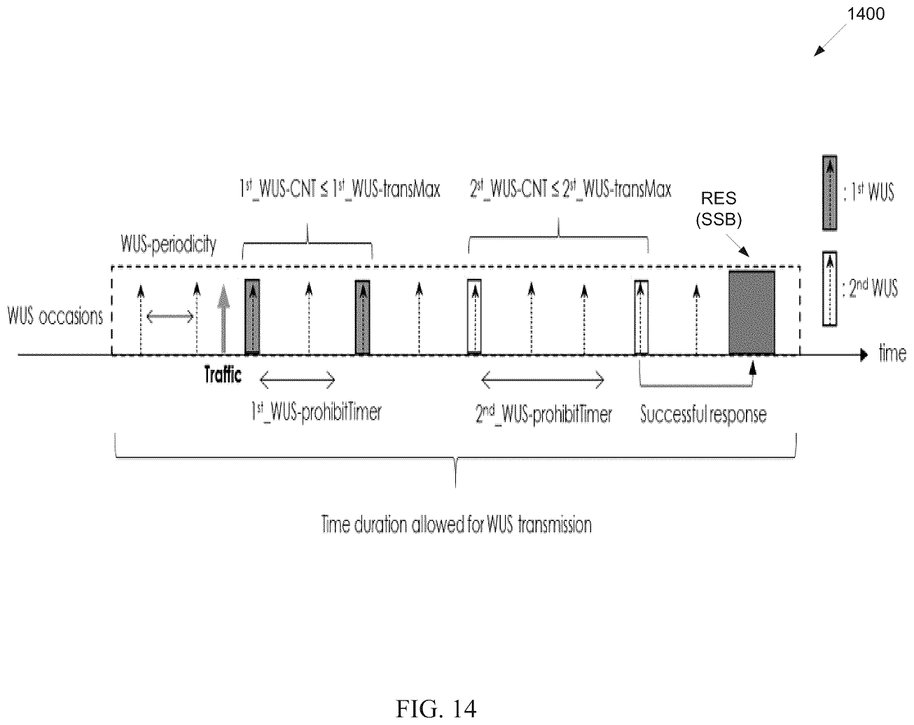

FIG. 14 illustrates an example of UE for transmitting a first WUS and a second WUS 1400 according to various embodiments of the present disclosure. An embodiment of the UE (e.g., 111-116 as illustrated in FIG. 1) for transmitting a first WUS and a second WUS 1400 shown in FIG. 14 is for illustration only.

As illustrated in FIG. 13, a UE is provided from a serving gNB by a higher layer signaling a set of parameters related to WUS transmission in step 1310. The set of parameters include WUS-transMax, WUS-prohibitTimer, WUS transmission power control parameters, and WR monitoring window configurations, etc. The higher layer signaling can be SIB or UE-specific RRC signaling. The UE performs a first WUS transmission with an initial transmission power value, if triggering conditions are met in step 1320.

FIG. 14 illustrates an example that a triggering condition for WUS transmission is based on a traffic arrival during time duration allowed for WUS transmission. The triggering conditions are also provided to the UE via higher layer signaling such as SIB or UE-specific RRC signaling. The UE waits for a response on the reception of the WUS and/or SSB/SIB from the serving gNB during the WUS response (WR) monitoring window in step 1330. The UE expects to receive a response and/or SSB/SIB from the serving gNB within the WR monitoring window as illustrated in FIG. 10. If no response is received during WR monitoring window, the UE performs subsequent WUS transmissions following WUS-prohibitTimer and power ramping between consecutive WUS transmissions until a successful WUS transmission or the WUS-transMax counter is reached in step 1340. As illustrated in FIG. 14, the WUS retransmissions follow parameters provided in step 1310 such as WUS-transMax and WUS-prohibitTimer.

A UE is provided by higher layer signaling WUS-transMax value, which indicates the maximum number of WUS transmissions allowed for a UE for a given series of WUS transmissions, i.e., initial transmission and subsequent retransmissions, or for a given WUS transmission time window. A UE may be also provided by higher layer signaling WUS-prohibitTimer, which indicates the minimum time between consecutive WUS transmissions, i.e., a UE cannot transmit another WUS within the WUS-prohibitTimer starting from the previous WUS transmission.

As illustrated in FIG. 14, a UE maintains the number of WUS transmissions, denoted by WUS-CNT, for a given series of WUS transmissions or for a given WUS transmission window. After a failed WUS transmission, i.e., receiving no response and/or SSB from the serving gNB within the WR monitoring window, the UE can transmit the next WUS in a WUS occasion at least WUS-prohibitTimer after the preceding WUS transmission. In one example, the WUS-prohibitTimer starts after the end of a WUS transmission. The WUS-prohibitTimer values can be indicated to the UE in a number of slots, subframes or in ms, e.g., {ms1, ms2, ms4, ms8, ms16, ms32, ms64, ms128}. After the UE retransmits WUS, the WUS-CNT is increased by 1. The UE can retransmit WUS until WUS-CNT is less than or equal to WUS-transMax. After that, the UE may not further transmit WUS for the given series of WUS transmissions or for the remaining WUS transmission window duration. In one example, the WUS-transMax can take values from {n4, n8, n16, n32, n64}. In another example, the WUS-transMax can take values from {n3, n4, n5, n6, n7, n8, n10, n20, n50, n100, n200}.

A UE is provided from a serving gNB by a higher layer signaling a set of parameters related to WUS transmission power control. In one example, the WUS transmission power, P_{WUS}^{TX}, is determined as P_{WUS}^{TX}=min{P_{CMAX, f,c}, P_{WUS}^{target_RX}+PL_{b,f,c}}, where P_{CMAX,f,c} is the configured maximum UE transmission power for carrier “f” and serving cell “c,” and PL_{b,f,c} is the UE measured pathloss on uplink BWP “b,” carrier “f” and serving cell “c.” The target WUS reception power, P_{WUS}^{target_RX}, at the serving gNB is determined as P_{WUS}^{target_RX}=p_{WUS}^{target_RX}+Δ+(CNT_{WUS}^{power_ramping}−1)·Δₛₜₑₚ with the following parameters provided to the UE.

p_{WUS}^{target_RX} is a target WUS received power at the serving gNB, provided by higher layer signaling in dBm.

Δ is an adjustment value to the target WUS received power p_{WUS}^{target_RX} at the serving gNB. This value may be predefined by specification or indicated to the UE by higher layer signaling in dB. The value may be also dependent on the SCS numerology μ, e.g., Δ=c₁+c₂·μ dB. The value may be configured only for a certain type of WUS signal, e.g., PRACH preamble based WUS.

Δₛₜₑₚ is the WUS transmission power increment in dB for power ramping.

In such equation, CNT_{WUS}^{power_ramping} is the WUS power ramping counter maintained by the UE. The CNT_{WUS}^{power_ramping} may be the same as WUS-CNT or it may be different. For instance, CNT_{WUS}^{power_ramping} may not be increased with the increment of WUS-CNT, if physical layer has provided an instruction to MAC layer to the suspend power ramping, e.g., when the UE changes its WUS transmit beam, etc.

A UE is also provided from a serving gNB by a higher layer signaling the WR monitoring window durations, during which the UE monitors a response and/or SSB from the serving gNB in response to the WUS transmission. The WR monitoring window may start from the end of WUS transmission with or without a certain time offset to account for UE Tx-Rx turnaround time, etc. Such a time offset may be predefined in the specifications of the system operation or indicated to the UE.

In one example, the time offset from the end of WUS transmission to the start of WR monitoring window can be one symbol. The WR monitoring window durations can be provided to the UE in number of slots or in ms, e.g., {sl1, sl2, sl4, sl8, sl10, sl20, sl40, sl80}.

Alternatively, the WR monitoring window durations can be provided to the UE in an integer multiple of normal SSB periodicity or an integer multiple of PDCCH monitoring periodicity for a DCI format scheduling WUS response message. In this case, the WR monitoring window starts from the first SSB occasion or the first PDCCH monitoring occasion for a DCI format, scrambled by SI-RNTI or RA-RNTI, scheduling WUS response message after transmitting the WUS. In one example, the PDCCH providing a DCI format scheduling WUS response message and/or SSB may be transmitted by the serving gNB at any time, not subject to their periodic occasions, during the WUS response monitoring window. In this example, the UE may continuously monitor a response and/or SSB from the serving gNB during the entire WUS response monitoring window. When the UE monitors a PDCCH providing a DCI format scheduling WUS response message, the search space can be any of a USS set or a CSS set, such as Type 0/0A/1/2/2A/3.

SSB/SIB transmission intervals have a fixed periodicity. Such a fixed SSB periodicity and SIBs, such as SIB1 scheduled by MIB and other SIBs scheduled by SIB1, limits the flexibility of network adaptation and the network energy saving gain in a time domain. Therefore, there is a need to define procedures and methods for a UE to request a serving gNB to provide SSB and/or SIBs, e.g., by transmitting a wake-up signal (WUS), and for the UE to receive SSB and/or SIB(s) transmitted by the serving gNB based on the demand. The WUS transmission decisions by UEs cannot be arbitrary. Therefore, there is another need to define procedures and methods for a UE to decide an WUS transmission based on certain triggering conditions.

A system may utilize more than one types of WUS to tailor the use of WUS for a particular situation. For example, different types of WUS may be associated with different conditions to use such as synchronization requirements, or with different traffic types triggering the WUS transmission upon arrival. Therefore, there is a need to define procedures and methods to provide more than one types of WUS to a UE, which may be further associated with respective time domain transmission occasions, frequency domain resources, WUS triggering conditions, WUS transmission parameters, or other conditions to use the respective WUS types.

When one or more transmissions of a certain type of WUS fail, i.e., no response/SSB is received from a serving gNB, it may be beneficial to switch from one type of WUS to another type of WUS. Therefore, there is a need to define procedures and methods for a UE to switch from one type of WUS to another type of WUS.

When a WUS transmitted by a UE and/or a response message transmitted by a serving gNB upon reception of a WUS allow additional information to be transmitted, the UE may indicate more specific requests to the serving gNB in a WUS transmission such as on-demand SI request and/or the serving gNB may also provide more specific information to the UE in a response message such as one or more indexes of serving cells or cell groups to be activated. Therefore, there is another need to define procedures and methods for a UE to provide additional information in a WUS transmission and/or to receive additional information in a response message.

The present disclosure relates to a communication system. The disclosure relates to defining functionalities and procedures for adapting availability of SSB and/or SIBs based on the demand in order to support network energy savings for a cell.

The present disclosure further relates to defining procedures and methods for a UE to request a serving gNB to provide SSB and/or SIBs, e.g., by transmitting WUS, and for the UE to receive SSB and/or SIB transmitted by the serving gNB based on the demand.

The present disclosure also relates to defining procedures and methods for a UE to receive information regarding more than one types of WUS, which may be further associated with respective time domain transmission occasions, frequency domain resources, WUS triggering conditions, WUS transmission parameters, or other conditions to use the respective WUS types.

The present disclosure additionally relates to defining procedures and methods for a UE to switch from one type of WUS to another type of WUS.

The present disclosure also relates to defining procedures and methods for a UE to provide additional information in a WUS transmission and/or to receive additional information in a response message.

Embodiments of the disclosure for adapting availability of SSB and/or SIBs based on demand, for example in order to support network energy savings for a cell, are summarized in the following and are fully elaborated further below: (1) method and apparatus for a UE to request a serving gNB to provide SSB and/or SIBs, e.g., by transmitting WUS, and for the UE to receive SSB and/or SIB transmitted by the serving gNB based on the demand; (2) method and apparatus for a UE to receive information regarding more than one types of WUS, which may be further associated with respective time domain transmission occasions, frequency domain resources, WUS triggering conditions, WUS transmission parameters, or other conditions to use the respective WUS types; (3) method and apparatus for a UE to switch from one type of WUS to another type of WUS; and (4) method and apparatus for a UE to provide additional information in an WUS transmission and/or to receive additional information in a response message.

A UE is provided from a serving gNB by a higher layer signaling a set of parameters related to a first UL WUS and a set of parameters related to a second UL WUS in step 1310. The UE performs one or more transmissions of the first UL WUS based on the associated set of parameters, if conditions to use the first WUS are met in step 1320. If a response is received as a result of a transmission of the first UL WUS, the UE stops transmitting WUS in step 1330. If the conditions to use the first WUS are not met or no response is received as a result of one or more transmissions of the first UL WUS, the UE performs one or more transmissions of the second UL WUS based on the associated set of parameters, if conditions to use the second WUS are met in step 1340.

FIG. 14 illustrates an example procedure for a UE to transmit a first WUS and a second WUS following respective sets of associated parameters according to the present disclosure. The UE starts with transmitting the first WUS and proceeds to transmitting the second WUS as the UE has not received a response as a result of transmitting the first WUS from the serving gNB.

A set of parameters related to a first UL WUS and a set of parameters related to a second UL WUS are provided to a UE from a serving gNB as exemplified below.

Time domain resources for transmitting the first UL WUS and the second UL WUS, respectively. For example, a UE is provided WUS_{periodicity} and WUS_{offset}, e.g., in a number of slots, for the first UL WUS and the second UL WUS respectively, such that the UE may transmit an WUS at time slots, WUSₛₗₒₜ, satisfying the equation: (SFN·Nₛₗₒₜ^{frame,μ}+WUSₛₗₒₜ−WUS_{offset}) mod WUS_{periodicity}=0, where Nₛₗₒₜ^{frame,μ} is the number of slots within a frame for a given sub-carrier spacing configuration numerology μ. A UE may be also provided from a serving gNB a starting symbol position and a duration, e.g., in a number of symbols, for the first WUS and the second WUS, respectively, within a slot identified as WUS occasions.

An WUS may be transmitted with beam sweeping, i.e., a series of WUS transmissions towards different beamforming directions, and/or with repetition, i.e., a series of WUS transmissions towards a same beamforming direction. The UE is indicated by a higher layer signaling parameters related to WUS transmissions with beam sweeping or repetition.

Frequency domain resources for transmitting the first UL WUS and the second UL WUS, respectively. For example, the UE is provided a set of parameters corresponding to a certain frequency range for WUS transmission, including a starting PRB index, startPRB, and a number of PRBs, nrofPRBs, for the first UL WUS and the second UL WUS, respectively.

WUS triggering conditions for a transmission of the first UL WUS and the second UL WUS, respectively. There may be conditions commonly apply to both the first UL WUS and the second UL WUS, while there may be conditions separately apply to either one of the first UL WUS or the second UL WUS. In one example, a UE is provided with one or more indexes of logical channels, or LCGs, and an WUS transmission is triggered at the UE when traffics for those indicated logical channels or LCGs arrive during a certain time period, e.g., a time duration allowed for WUS transmissions. A common set of logical channel indexes or LCG indexes may apply to both the first UL WUS and the second UL WUS.

Alternatively, different sets of logical channel indexes or LCG indexes may be indicated to the UE for the first UL WUS and the second UL WUS, respectively. For instance, if a new traffic arrives for the logical channels or LCGs associated with the second WUS but not the first WUS, the UE starts with transmitting the second WUS while skipping the first WUS.

Synchronization requirements associated with the first UL WUS and the second UL WUS, respectively. For example, conditions for transmitting the first WUS are associated with more accurate synchronization requirements such that the UE transmits the first WUS only when the synchronization requirements are met. Otherwise, although other triggering conditions such as traffic-based conditions are met, the UE skips transmitting the first WUS and may directly start with transmitting the second WUS. The synchronization requirements may be indicated to the UE via a higher layer signaling or predefined in the specifications of the system operation.

In one example, a synchronization requirement is indicated or predefined in terms of the time elapsed since the last reception of a reference signal which can be used for synchronization including but not limited to SSB, CSI-RS, PTRS, TRS, or DMRS. A type of reference signal may be also indicated to the UE or predefined in the specifications of the system operation. If the time elapsed since the last reception of a reference signal on a cell is less than a certain threshold value, e.g., SyncTimer, indicated to the UE or predefined in the specifications of the system operation, the UE initiates a transmission of the first WUS signal on the cell or on another cell in the same cell group with the cell, if other triggering conditions are met. If the time elapsed since the last reception of a reference signal on a cell exceeds SyncTimer, the UE skips the first WUS and starts with a transmission of the second WUS signal on the cell or on another cell in the same cell group with the cell, if other triggering conditions are met. The SyncTimer may be indicated to the UE in a number of slots, ms, or a multiple of SSB periodicity.

In one example, synchronization requirements are based on a determination of Out-of-Sync based on measurements of reference signals and the BLER calculated assuming a hypothetical PDCCH transmission compared to a certain threshold. For instance, if the BLER is worse than a certain threshold value for a certain consecutive number of times, the Out-of-Sync is determined and the UE skips transmitting the first WUS and starts with the second WUS. Otherwise, the UE starts with the first WUS. The measurements obtained during UE C-DRX and cell DTX are excluded in the BLER evaluations.

There may be other conditions associated with the first UL WUS and the second UL WUS, respectively. In one example, conditions for transmitting the first WUS are associated with a pathloss measured on a cell in which the WUS is intended to be transmitted. For instance, if a pathloss measured on a cell is less than a certain threshold value provided to the UE, e.g., in dBm or via an index to a range of values, the UE starts with transmitting the first WUS. Otherwise, the UE skips transmitting the first WUS and starts with transmitting the second WUS. Similarly, L1 measurement quantities such as RSRP, RSRQ, or SINR can be associated with the condition. For instance, if the RSRP, RSRQ, or SINR on a cell is greater than a certain threshold value provided to the UE, the UE starts with transmitting the first WUS. Otherwise, the UE skips transmitting the first WUS and starts with transmitting the second WUS.

The UE is provided from the serving gNB via higher layer signaling parameters related to the first WUS and the second WUS, respectively. An WUS may be based on one or more existing signals or channels such as scheduling request (SR) using PUCCH, PRACH preambles, and SRS. Alternatively, a new signal, e.g., based on a sequence such as m-sequence, ZC-sequence, can be defined for the purpose of WUS. A signal type for the first WUS and the second WUS can be predefined in the specifications of the system operation or indicated to the UE via higher layer signaling such as SIB or UE-specific RRC signaling.

The UE is also provided a set of parameters for transmissions of the first WUS and a set of parameters for transmissions of the second WUS, respectively, as illustrated in FIG. 14. The WUS-transMax is the maximum number of WUS transmissions allowed for a UE for a given series of WUS transmissions or for a given WUS transmission time window. The WUS-prohibitTimer is the minimum time between consecutive WUS transmissions, i.e., a UE cannot transmit another WUS within the WUS-prohibitTimer starting from the previous WUS transmission. WUS transmission power control parameters such as parameters for determining initial transmission power value and for determining transmission power values for subsequent transmissions with power ramping. The WR monitoring window is a time window during which a UE expects to receive a response and/or SSB from the serving gNB after transmitting an WUS. If the UE does not receive a response and/or SSB from the serving gNB during the WR monitoring window, the UE proceeds to attempt the next WUS transmission.

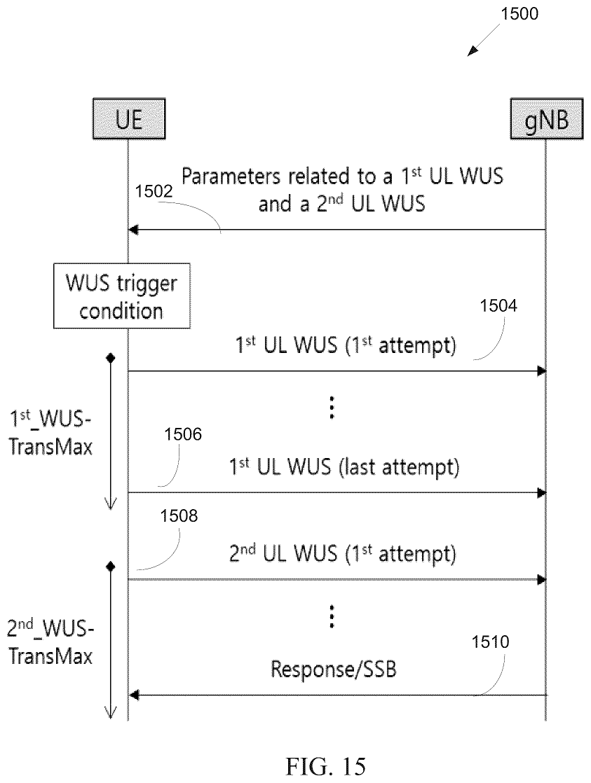

FIG. 15 illustrates a signaling flow of method 1500 for transmitting a first UL WUS and a second UL WUS between a UE and a gNB according to various embodiments of the present disclosure. The method 1500 as may be performed by a UE (e.g., 111-116 as illustrated in FIG. 1) and a base station (e.g., 101-103 as illustrated in FIG. 1). An embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, in step 1502, a gNB sends, to a UE, parameters related to a 1^{st} UL WUS and a 2^{nd} UL WUS. In step 1504, the UE sends the 1^{st} UL WUS at the 1^{st} attempt to the gNB and in step 1506, the UE sends the 1^{st} UL WUS at last attempt. In step 1508, the UE sends the 2^{nd} UL WUS to the gNB. In step 1510, the gNB sends the response and SSB to the UE.

The UE receives parameters related to a first WUS and a second WUS. In one example, the first WUS is based on PUCCH with a certain PUCCH format and the second WUS is based on PRACH with a certain preamble format. PUCCH Format 0/1/2/3/4 can be used as an WUS and the UE is indicated other applicable parameters such as startingSymbolIndex, nrofSymbols, startingPRB, secondHopPRB if frequency hopping is enabled, and timeDomainOCC. Long/short preamble with a certain format, e.g., Format 0/1/2/3 or Format A1/A2/A3/B1/B2/B3/B4/C0/C2, can be used as an WUS and the UE is indicated other applicable parameters such as a certain reserved set of preambles, e.g., root sequences and/or cyclic shifts, for a given preamble format.

For an WUS based on PRACH preambles, in one example, the UE is indicated by a higher layer signaling one or more indexes of PRACH preambles and an associated usage of the respective one or more indicated preambles. As an example, a certain PRACH preamble has a dedicated purpose of requesting on-demand SSB. Similarly, another certain PRACH preamble has a dedicated purpose of requesting on-demand SIBs, which may be further associated with a specific set of SIBs requested.

In another example, the UE is indicated by a higher layer signaling a pool of PRACH preambles, e.g., via a list of more than one preamble indexes or a range of preamble indexes. Each preamble in the pool may not be associated with a certain purpose and the UE may randomly select a preamble from the pool of preambles for WUS transmission. In one example, the first WUS and the second WUS are both based on PRACH preambles, while the first WUS is by transmitting a pre-allocated preamble and the second WUS is by transmitting a randomly selected preamble from a pool of preambles. The UE may select a new preamble, or use the same preamble from the initial WUS transmission, for respective subsequent WUS transmissions after a failed WUS transmission.

In another example, the first WUS is by transmitting a randomly selected preamble from a pool of preambles, while the second WUS is by transmitting a pre-allocated preamble. In yet another example, the first WUS is by transmitting a randomly selected preamble from a pool of preambles, and the second WUS is by transmitting a randomly selected preamble from another pool of preambles.

As illustrated in FIG. 15, the UE transmits the first WUS with initial transmission power when triggering conditions are met. There are parameters associated with transmitting the first WUS such as WUS-transMax, WUS-prohibitTimer, WUS transmission power control parameters, and WR monitoring window, etc. The UE waits for a response and/or SSB during the WR monitoring window. If no response/SSB is received during the WR monitoring window, the UE proceeds to a next WUS transmission after at least WUS-prohibitTimer with possible power ramping between consecutive WUS transmissions according to the WUS transmission power control parameters. The UE continues transmitting the first WUS according to the associated parameters until a response/SSB is received or until WUS-transMax for the first WUS is reached.

If no response/SSB is received until WUS-transMax is reached, the UE starts transmitting the second WUS according to the parameters associated with the second WUS such as WUS-transMax, WUS-prohibitTimer, WUS transmission power control parameters, and WR monitoring window, etc. Similar to the first WUS transmissions, the UE continues transmitting the second WUS according to the associated parameters until a response and/or SSB is received or until WUS-transMax for the second WUS is reached.

In one example, the UE starts with transmitting the first WUS when triggering conditions are met and the UE is In-Sync. If triggering conditions are met while the UE has lost uplink synchronization, i.e., Out-of-Sync, the UE may skip transmitting the first WUS and may start with transmitting the second WUS.

Additional information may be included in an WUS transmission to a serving gNB. For instance, if an WUS is based on PUCCH, PUCCH Format 0/1 allows 1 or 2 bits payload size, while PUCCH Format 2/3/4 allows larger than 2 bits payload size depending on the allocated number of RBs, allocated number of symbols, and maxCodeRate. Other WUS types such as those based on SRS or PRACH may also allow transmitting a few bits, e.g., 1 or 2 bits, using code domain representations. In the case of a PRACH-based WUS, additional information can be sent to a gNB by transmitting a specific PRACH preamble, e.g., in terms of a length, root sequence or cyclic shift, allocated for a certain purpose.

When an WUS allows transmitting additional information, the UE may indicate one or more of the following elements in an WUS transmission: (1) one or more serving cell or cell group indexes for which an activation is requested; (2) system Information (SI) requests, in one example, it can be a binary indication requesting to transmit SI, and in another example, it can be a bitmap indicating one or more indexes of SIBs or sets of SIBs requesting to be transmitted; and (3) information related to the triggering conditions. For instance, if triggering conditions are based on a traffic arrival of certain logical channels or LCGs, the index(es) of logical channel(s) or LCG(s) having new traffic arrival can be indicated in the WUS.

A response from a serving gNB to a UE in response to a reception of an WUS can be a transmission of SSB and/or SIBs. In another example, a response from a serving gNB to a UE can be a transmission of a PDCCH providing a certain DCI format, where the PDCCH search space set can be a CSS set or a USS set. In one example, a UE may receive a PDCCH providing a DCI format 2_9 providing activation/deactivation of cell DTX/DRX. In another example, a UE may receive a PDCCH providing a DCI format scheduling PUSCH or PDSCH.

In yet another example, a UE may receive a PDCCH providing a new DCI format defined for the purpose of providing a response to a reception of an WUS. The PDCCH providing a DCI format may be scrambled by NES-RNTI, SI-RNTI, RA-RNTI, PS-RNTI, or any new RNTI. In one example, the PDCCH providing a DCI format is scrambled by RA-RNTI as a response to a reception of an WUS based on PRACH preambles. In this case, the DCI format may provide an uplink scheduling information for the UE to provide further information to the serving gNB.

In a response message, the UE may be indicated one or more of the following elements: (1) an acknowledgement on the reception of UL WUS; (2) an acknowledgement on a request on the on-demand SI; (3) one or more indexes of SIBs to be provided and the scheduling information; (4) one or more indexes of serving cells or cell groups to be activated; (5) active DL/UL BWP index for the respective one or more serving cells indicated to be activated; and (6) one or more indexes of serving cells on which on-demand SSB may be transmitted.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE), the method comprising:
receiving information related to transmission of a wake-up signal (WUS), wherein the information includes at least a resource configuration and a triggering condition;
transmitting, based on (i) the resource configuration and (ii) whether the triggering condition is met, the WUS;
receiving an on-demand synchronization signal block (SSB) or an on-demand system information block (SIB) on a cell; and
determining synchronization or system information on the cell.

2. The method of claim 1, wherein the resource configuration indicates at least:
time-domain parameters including at least one of:
a periodicity,
an offset,
a starting symbol offset, and
a duration, and
frequency-domain parameters including at least one of:
a starting frequency, and
a bandwidth.

3. The method of claim 1, wherein:
the WUS is based on physical random access channel (PRACH) preambles, and
the information related to the WUS transmission includes dedicated PRACH preamble resources.

4. The method of claim 1, wherein the triggering condition is related to:
traffic for a logical channel or logical channel group including:
a packet arrival,
a buffered traffic amount, or
a packet delay,
a synchronization status, or
a time elapsed since a last reception of a channel or a signal.

5. The method of claim 1, wherein the information related to the WUS transmission further includes at least one of:
a maximum number of allowed transmissions,
a minimum time between consecutive WUS transmissions,
parameters related to power control, and
parameters related to a response monitoring window.

6. The method of claim 1, wherein receiving the on-demand SSB or the on-demand SIB comprises receiving the on-demand SIB based on monitoring a physical downlink control channel (PDCCH) according to a type 0 common search space (CSS) providing a DCI format scrambled by a system information radio network temporary identifier (SI-RNTI) for a certain time window.

7. The method of claim 1, wherein the WUS transmission is repeated more than one time towards a same beam direction or different beam directions.

8. A user equipment (UE), comprising:
a transceiver configured to:
receive information related to transmission of a wake-up signal (WUS), wherein the information includes at least a resource configuration and a triggering condition;
transmit, based on (i) the resource configuration and (ii) whether the triggering condition is met, the WUS; and
receive an on-demand synchronization signal block (SSB) or an on-demand system information block (SIB) on a cell; and
a processor operably coupled to the transceiver, the processor configured to determine synchronization or system information on the cell.

9. The UE of claim 8, wherein the resource configuration indicates at least:
time-domain parameters including at least one of:
a periodicity,
an offset,
a starting symbol offset, and
a duration, and
frequency-domain parameters including at least one of:
a starting frequency, and
a bandwidth.

10. The UE of claim 8, wherein:
the WUS is based on physical random access channel (PRACH) preambles, and
the information related to the WUS transmission includes dedicated PRACH preamble resources.

11. The UE of claim 8, wherein the triggering condition is related to:
traffic for a logical channel or logical channel group including:
a packet arrival,
a buffered traffic amount, or
a packet delay,
a synchronization status, or
a time elapsed since a last reception of a channel or a signal.

12. The UE of claim 8, wherein the information related to the WUS transmission further includes at least one of:
a maximum number of allowed transmissions,
a minimum time between consecutive WUS transmissions,
parameters related to power control, and
parameters related to a response monitoring window.

13. The UE of claim 8, wherein the transceiver is further configured to receive the on-demand SIB based on monitoring of a physical downlink control channel (PDCCH) according to a type 0 common search space (CSS) providing a DCI format scrambled by a system information radio network temporary identifier (SI-RNTI) for a certain time window.

14. The UE of claim 8, wherein the WUS transmission is repeated more than one time towards a same beam direction or different beam directions.

15. A base station (BS), comprising:
a processor; and
a transceiver operably coupled to the processor, the transceiver configured to:
transmit information related to reception of a wake-up signal (WUS), wherein the information includes at least a resource configuration and a triggering condition;
receive, based on (i) the resource configuration and (ii) whether the triggering condition is met, the WUS; and
transmit an on-demand synchronization signal block (SSB) or an on-demand system information block (SIB) on a cell.

16. The BS of claim 15, wherein the resource configuration indicates at least:
time-domain parameters including at least one of:
a periodicity,
an offset,
a starting symbol offset, and
a duration, and
frequency-domain parameters including at least one of:
a starting frequency, and
a bandwidth.

17. The BS of claim 15, wherein:
the WUS is based on physical random access channel (PRACH) preambles, and
the information related to the WUS reception includes dedicated PRACH preamble resources.

18. The BS of claim 15, wherein the triggering condition is related to:
traffic for a logical channel or logical channel group including:
a packet arrival,
a buffered traffic amount, or
a packet delay,
a synchronization status, or
a time elapsed since a last reception of a channel or a signal.

19. The BS of claim 15, wherein the information related to the WUS reception further includes at least one of:
a maximum number of allowed transmissions,
a minimum time between consecutive WUS reception,
parameters related to power control, and
parameters related to a response monitoring window.

20. The BS of claim 15, wherein the transceiver is further configured to transmit the on-demand SIB on a type 0 physical downlink control channel (PDCCH) according to a common search space (CSS) providing a DCI format scrambled by a system information radio network temporary identifier (SI-RNTI) for a certain time window.
